(19) United States
(12) Patent Application Publication
(10) Pub. No.: US 2009/0188992 A1
(43) Pub. Date: Jul. 30, 2009

(54) SPRINKLER WATERING SET WITH MULTI-STAGE WATERING FUNCTION

(76) Inventor: Yenkun HSUEH, Ta Li City (TW)

Correspondence Address: SINORICA, LLC, 2275 Research Blvd., Suite 500, ROCKVILLE, MD, 20850, US

(21) Appl. No.: 12/019,289

(22) Filed: Jan. 24, 2008

(51) Int. Cl. B05B 3/08

(52) U.S. Cl. 239/231

(57) ABSTRACT

The present invention relates to a sprinkler watering set with multi-stage watering function, wherein the watering control cap is installed with first, second watering tanks, and third watering hole; and first watering tank is installed with two first watering holes. The first watering tank is installed with several second watering holes; said watering control cap is to match the cap board; said cap board is installed with first, second, and third inlet holes, wherein first inlet hole corresponds to first watering tank on watering control cap, second inlet hole corresponds to second watering tank on watering control cap, and third inlet hole corresponds to third watering tank on watering control cap. By rotating watering control cap, it is connected to the first, second, and third inlet holes on cap board of watering control cap and linked to watering section installed on main body for controlling watering amount.

### BACKGROUND OF THE INVENTION

(a) Field of the Invention

The present invention relates to a sprinkler watering set with multi-stage watering function, particularly a technique in the application of watering set.

(b) Description of the Prior Art

FIG. 7 shows a sprinkler of prior art, wherein the watering control pipe 60 of the sprinkler is connected to the top cap 70 through the connecting pipe 50; said top cap 70 is installed with inlet 71 and interlocking section 72, and said top cap 70 is closed with a bottom cap 90, whereas a water stopper is installed between the top cap 70 and bottom cap 90. In addition, the bottom cap 90 is installed with a connection section 91; said connection section 91 is interlocked with a connection part 92, and one end of said connection part 92 is fixed on the interlocking section 72 installed on the top cap 70 so that the top cap 70 can be closed with the bottom cap 90. Also, the bottom cap 90 is installed with several watering holes 93, wherein water enters from the watering control pipe 60 of the sprinkler and the connecting pipe 50 before flowing into the inlet 71 of the top cap 70 and sprinkles from the watering hole 93 of the bottom cap 90. However, such sprinkler has the following drawbacks:

1. The amount of watering is not selectable. The water after entering the watering control pipe and connection pipe of the sprinkler flows into the inlet of top cap before sprinkling out from the watering hole of bottom cap. The entering water sprinkles out from the outlet of the bottom cap immediately and hence the amount of water is not selectable.

2. Waste water resource. The water after entering the watering control pipe and connection pipe of the sprinkler flows into the inlet of top cap before sprinkling out from the watering hole of bottom cap. The entering water sprinkles out from the outlet of the bottom cap immediately. There is no way to control the amount of watering amount and hence wastes water resource.

### SUMMARY OF THE INVENTION

### <Motive of New Invention>

In view of above stated problem, the present invention aims at improving the problem of unable to select watering amount and wastage of water resource for sprinkler of prior art and created the sprinkler watering set with multi-stage watering function of the present invention.

### <Purpose of New Invention>

The main purpose of the present invention is to provide a sprinkler watering set with multi-stage watering function. Its main body is installed with inlet section and outlet section, and said main body is connected to a watering control cap, whereas a water stopper is installed between said main body and watering control cap, and the watering control cap is installed with two watering tanks and a watering hole; said watering control cap is to close a cap board; said cap board is installed with the first, second, and third inlet holes, wherein first inlet hole is corresponding to the watering tank installed on the watering control cap, the second inlet hole is corresponding to the other watering tank installed on the watering control cap, whereas the third inlet hole is corresponding to the watering hole installed on the watering control cap; through rotating the watering control cap, the connection to the first, second, and third inlet holes installed on the cap board of the watering control cap is linked to the watering section installed on the main body respectively, in order to control one of the watering tank and watering hole installed on the watering control cap so as to achieve the effect of controlling watering amount and saving water resource.

### BRIEF DESCRIPTION OF THE DRAWINGS

FIG. 1 shows the perspective view of the assembly state of the present invention.

FIG. 2 shows the perspective view of the exploded state of the present invention.

FIG. 3 shows the cross-sectional view of the present invention.

FIG. 4 is the using state reference diagram of the present invention.

FIG. 5 shows the state of the combining state of the watering control cap with cap board of the present invention.

FIG. 6 shows the action state of the present invention.

FIG. 7 is the reference diagram of prior art of the present invention.

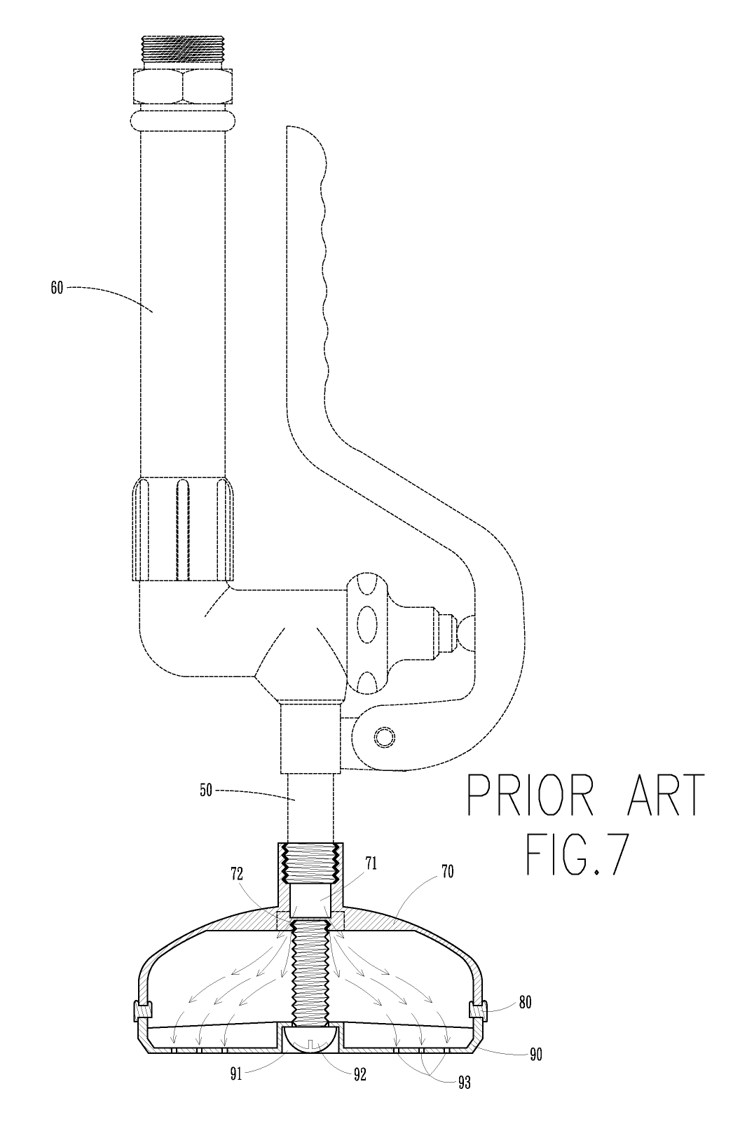

### DETAILED DESCRIPTION OF THE PREFERRED EMBODIMENTS

In order to allow the auditing committee to further understand the structure, features and others of the present invention, the preferred embodiment together with illustrations below is described in detail. However, the preferred embodiment in the illustrations is for the purpose of explanation and by not means the only restriction for this patent application.

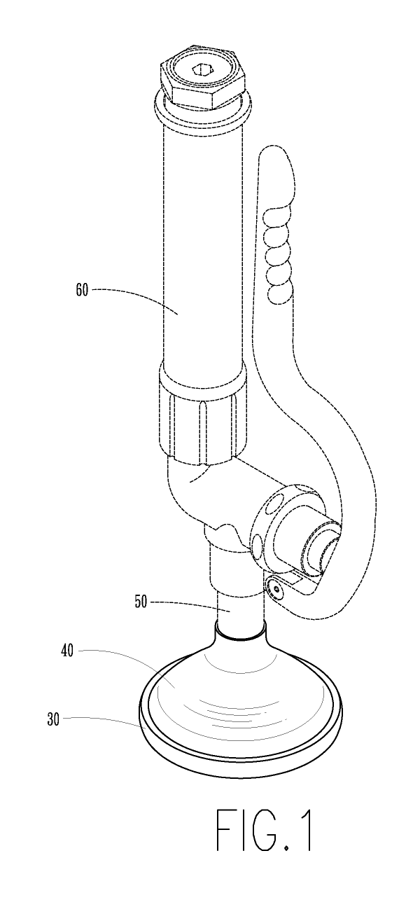

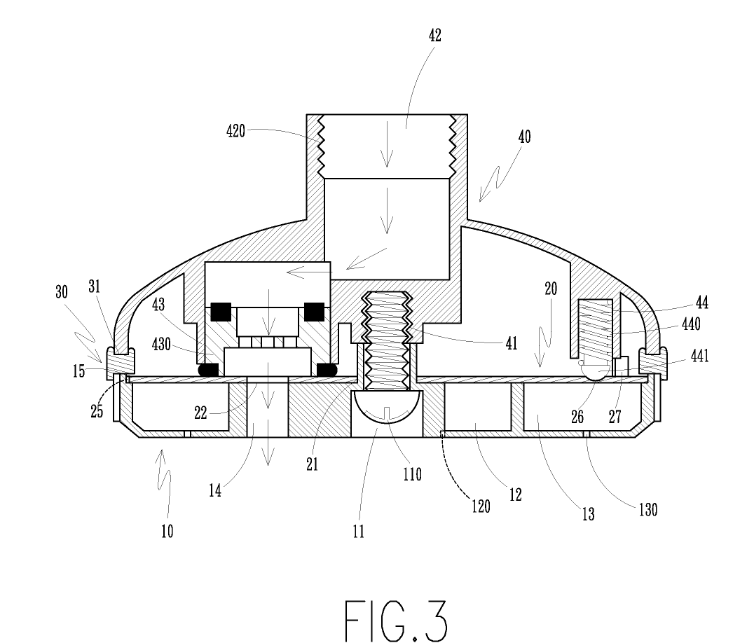

Refer to FIG. 1 through FIG. 3, wherein the illustrations show the perspective assembly, exploded view, and cross-sectional view of the sprinkler set with multi-stage watering function, which comprises:

A watering control cap 10, said watering control cap 10 is installed with a through-connection section 11, a first watering tank 12, a second watering tank 13, a third watering hole 14, and a positioning protruding section 15; whereas its through-connection section 11 is interlocked with a connecting part 110, and its first watering tank 12 is installed with several first watering hole 120, and the surrounding of second watering tank 13 is installed with several second watering holes 130;

A cap board 20, said cap board 20 is installed with a through-hole 21, a first inlet hole 22, a second inlet hole 23, and a third inlet hole 24; whereas the edge of cap board 20 is installed with a positioning clicked-in section 25; also the inner side of the edge of its cap board 20 is installed with several position supporting depressed section 26; and the edge of the two outermost position supporting depressed section 26 are installed with stopping protruding section 27; the positioning clicked-in section 25 installed on said cap board 20 is clicked in position with the positioning protruding section 15 installed on the watering control cap 10; and the through-hole 21 installed on the cap board 20 is positioned in the through-connection section 11 installed on the watering control cap 10 so that the first inlet hole 22 installed on the cap board 20 is linked to the first watering tank 12 installed on the watering control cap 10, and the second inlet hole 23 is linked to the second watering tank 13 installed on the watering control cap 10, whereas the third inlet hole 24 is linked to the third watering hole 14 installed on the watering control cap 10;

A water stopper 30, both sides of said water stopper 30 are installed with connecting clicked-in tank 31 & 32; the connecting clicked-in tank 31 installed on said water stopper 30 is clicked onto the edge of watering control cap 10 having cap board 20;

A main body 40, said main body 40 is installed with an interlocking section 41, an inlet section 42, a watering section 43, and a storage pillar 44; wherein said inlet section 42 is linked to watering section 43; and its inlet section 42 is installed with inner thread 420; in addition the watering section 43 is installed with a watering leakage stopper 430; and inside the storage pillar 44 is installed with an elastic part 440 and a supporting part 441; wherein the edge of said main body 40 is the connecting clicked-in tank 32 for closing with water stopper 30; and its interlocking section 41 is for interlocking with of the connecting part 110 through the through-connection section 11 of the watering control cap 10 so that the main body 40 can be tightly connected to the watering control cap 10 and water stopper 30; and the water stopper 430 installed on the watering leakage section 43 of its main body 40 corresponding to the first, second, and third inlet holes 21, 22, & 23 installed on the cap board 20 of the main body 10 can be separately rotated and linked; in addition, the elastic part 440 and supporting part 441 of the storage pillar 44 of the main body 40 can be elastically clicked in with the several position supporting depressed section 26 and stopper protruding section 27 installed on the cap board 20;

Through matching of above stated structure, the sprinkler watering set with multi-stage watering function of the present invention is completed.

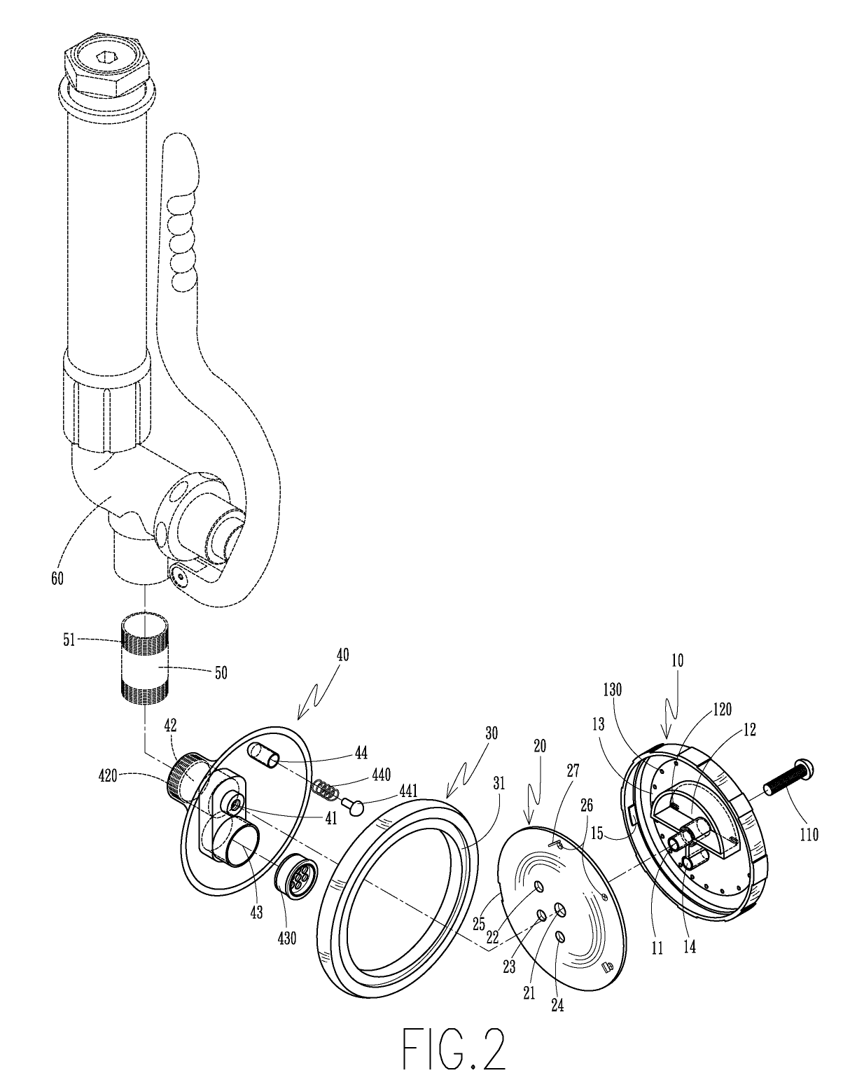

FIGS. 2 & 3 shows the perspective view and cross-sectional view of the sprinkler watering set with multi-stage watering function of present invention, wherein its main body 40 is installed with inlet section 42 and watering section 43; and said main body 40 is connected to watering control cap 10, whereas a water stopper 30 is installed between said main body 40 and watering control cap 10; and watering control cap 10 covers cap board 30, the first inlet hole 22 installed on said cap board 30 corresponds to the first watering tank 12 installed on watering control cap 10, whereas its second inlet hole 23 corresponds to the second watering tank 13 installed on watering control cap 10, in addition the third inlet hole 24 corresponds to the third watering hole 14 installed on watering control cap 10; through rotation of watering control cap 10, the first, second, and third inlet holes 22, 23 & 24 installed on cap board 20 connecting to watering control cap 10 is linked to the corresponding water leakage stoppers 430 installed on the watering section 43 of the main body 40; the first watering tank 12 corresponding to the first inlet hole 22 is installed with two first watering holes 120, while the second inlet hole 23 corresponding to several second watering holes 120 circularly installed on second watering tank 13, in addition its third inlet hole 24 corresponding to the third watering hole 14 of larger diameter; on rotation of watering control cap 10, the different amount of watering is controlled.

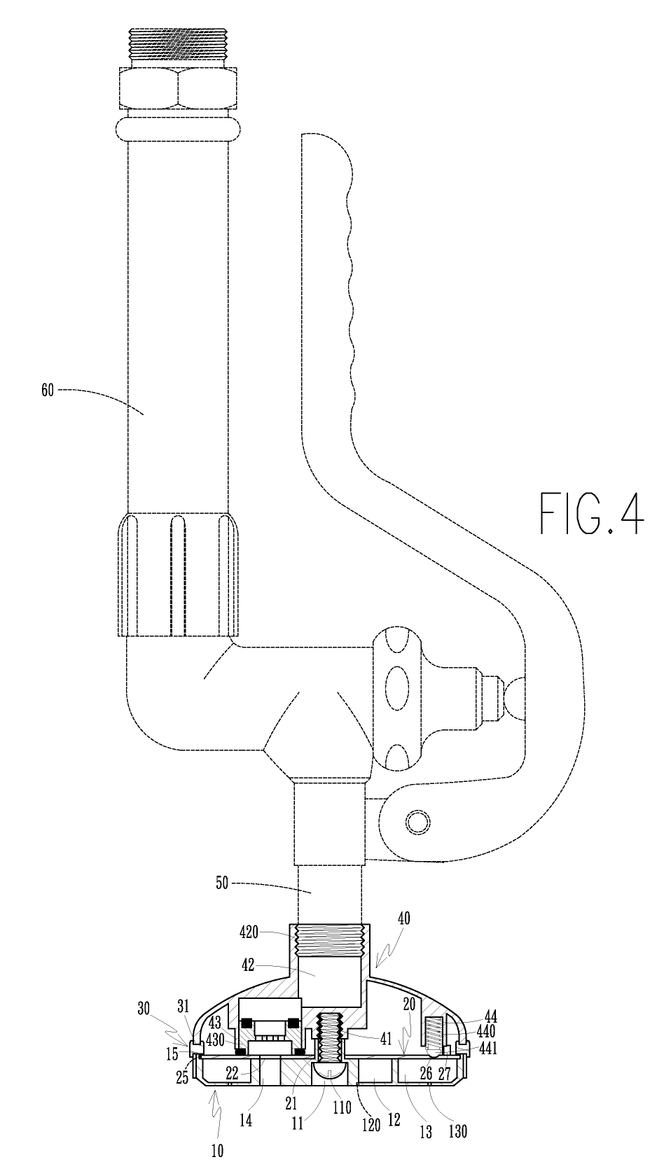

FIG. 4 is the illustration of the using state of sprinkler watering set of present invention, wherein it cap board 20 is closed on the watering control cap 10; and the edge of its watering control cap 10 is clicked on the connecting clicked-in tank 31 on one side of water stopper 30; whereas the edge of the other main body 40 is clicked onto the connecting clicked-in tank 32 on the other side of water stopper 30, and the through-connecting hole 11 of watering control cap 10 is interlocked with a connecting part 110; the end of said connecting part 110 is interlocked to the interlocking section 41 installed on main body 40, for the watering control cap 10 and water stopper 30 tightly interlocked with main body 40; and the outer thread 420 installed on the inlet section 42 of the main body 40 is for interlocking with the outer thread 51 installed on one end of connecting pipe 50, whereas the outer thread 51 installed on the other end of the connecting pipe 50 for interlocking with a sprinkler watering control pipe 60.

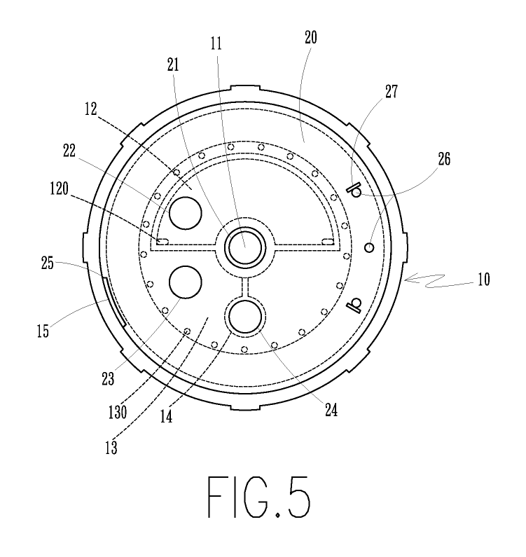

FIG. 5 is the illustration of the state of watering control cap in connection with cap board for the sprinkler watering set with multi-stage function of the present invention, wherein the positioning clicked-in section 25 installed on the cap board 20 is positioned and clicked on with the position protruding section 15 installed on watering control cap 10, and the through hole 21 installed on cap board 20 is positioned with the through-connection part 11 installed on the watering control cap 10 so that the first inlet hole 22 installed on cap board 20 is linked to the corresponding first watering tank 12 installed on the watering control cap 10; whereas the second inlet hole 23 is linked to the second watering tank 13 installed on the watering control cap 10; in addition the third inlet hole 24 is linked to the corresponding third watering hole 14 installed with larger diameter of watering control cap 10; and the first watering tank 12 is installed with two first watering holes 120; in addition the peripheral of the second watering tank 13 is circularly installed with several second watering holes 130. As the quantities and the size of watering holes are different, it is possible to control the amount of watering.

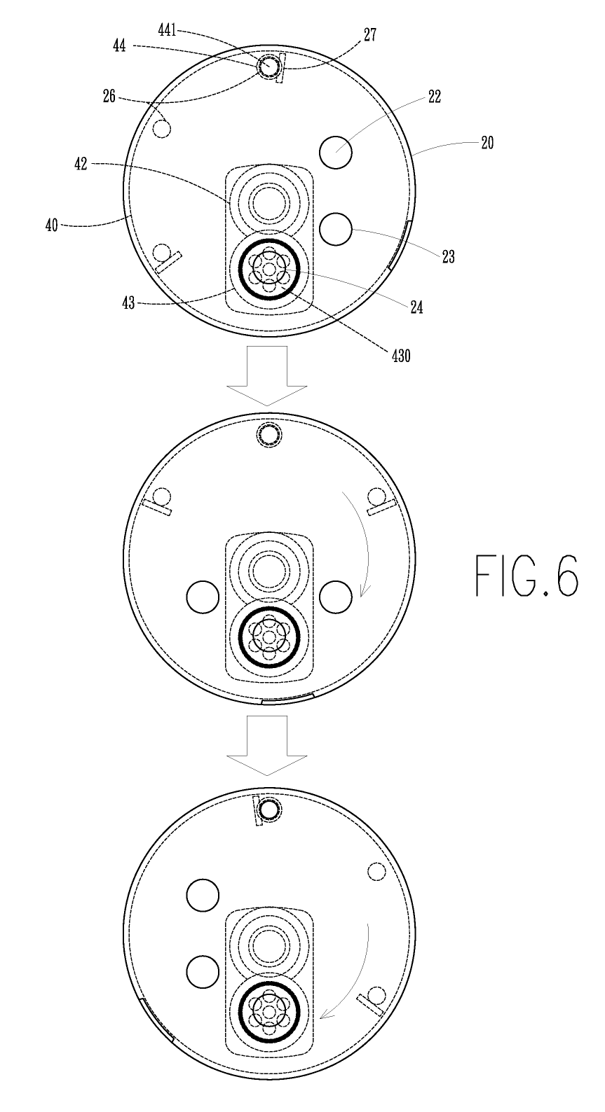

FIG. 6 is the illustration of the action state of the sprinkler watering set with multi-stage function of present invention, wherein the first, second, and third inlet holes 22, 23 & 24 installed on the cap board 20 are linked correspondingly to water stopper 430 installed on the watering section 43 of the main body 40; its first watering tank 12 corresponding to the first inlet hole 22 is installed with two first watering holes 120, and the second watering tank 13 corresponding to the second inlet hole 23 is circularly installed with several second watering holes 120, in addition its third inlet hole 14 with larger diameter corresponding to the third inlet hole 24, after rotating the watering control cap 10 installed with cap board 20, uses the first, second, and third inlet holes 22, 23, & 24 controlled by cap board 20, corresponding to the water stopper 430 installed on the watering section 43 of main body 40; and the elastic part 440 (not shown in the figure) and supporting part 441 installed inside the storage pillar 44 of the main body 40; engages in flexible positioning clicked-in control with the several positioning supporting depressed section 26 and stopping protruding section 27 installed in the cap board 20, in order to position control the water stopper 430 installed in the watering section 43 of the main body 40, and position link with the first, second, and third inlet holes 22, 23, & 24 of the cap board 20.

The discussion on the advantages of the present invention is hereby summarized below:

1. Selectable control of watering amount: Its watering control cap is installed with different quantity and sizes of watering holes for linking with water stopper installed in the watering section of the main body through rotation of watering control cap and therefore could be selected to control watering amount.

2. Saving of water resource: Its watering control cap is installed with different quantity and sizes of watering holes, therefore can be linked with the water stopper installed on the watering section of the main body and therefore could save water resource.

In summary, the present invention indeed could achieve the above stated functions and purposes. Therefore the present invention should meet the requirement of patent application and hence is filed according to the law.

I claim,

1. A sprinkler watering set with multi-stage watering function, comprising:
a watering control cap, said watering control cap is installed with a through-connection section, a first watering tank, a second watering tank, and a third watering hole, wherein its through-connection section is installed with a connecting part, and its first watering tank is installed with several first watering holes, and in addition its second watering tank is circularly installed with second watering holes;
a cap board, wherein said cap board is installed with a through hole, a first inlet hole, a second inlet hole, and a third inlet hole, said cap board is closed with watering control cap, and the through hole installed on the cap board go through the through-connection section installed on the watering control cap so that the first, second, and third inlet holes installed on the cap board is correspondingly linked to the first, second watering tanks and the third watering hole installed on the watering control cap;
a water stopper, said water stopper is closed with the cap board by clicked-in connection to the edge of watering control cap;
a main body, said main body is installed with an interlocking section, an inlet section and a watering section, its inlet section is linked to watering section, whereas its inlet section is installed with inner thread and the edge of main body is clicked-in connected to one side of water stopper, and its interlocking section is for interlocking with the connecting part installed on the through-connection section of watering control cap, so that the main body can be tightly sealed with water stopper, and the watering section installed on its main body corresponding to the first, second, and third inlet holes installed on the cap board of watering control cap for engaging in rotation linkage.

2. The sprinkler watering set with multi-stage watering function stated in claim 1, wherein the watering control cap is installed with a positioning protruding section, and the edge of cap board is installed with a positioning clicked-in section, the positioning clicked-in control section of said cap board is clicked in position with the positioning protruding section installed on the watering control cap, for the cap board to close with watering control cap into position.

3. The sprinkler watering set with multi-stage watering function stated in claim 1, wherein the inner side of said cap board is installed with several position supporting depressed section, and the main body is installed with a storage pillar, in the storage pillar an elastic part and a supporting part is installed, said elastic part and supporting part is flexibly clicked into position with the position supporting depressed section installed in the cap board.

4. The sprinkler watering set with multi-stage watering function stated in claim 3, wherein both edges of outermost side of the position supporting depressed section are installed with stopping protruding section, and the main body is installed with a storage pillar, in the storage pillar is installed with an elastic part and a supporting part; said elastic part and supporting part engages in limiting stop with the stopping protruding section installed in the cap board.

5. The sprinkler watering set with multi-stage watering function stated in claim 1, wherein each of both sides of said water stopper is installed with a connecting clicked-in tank; one side of said water stopper is clicked-in connected to the edge of watering control cap with closed cap board, whereas the connecting clicked-in tank installed on the other side of water stopper is clicked-in connected to the edge of the main body.

6. The sprinkler watering set with multi-stage watering function stated in claim 1, wherein the watering section of main body is installed with a watering leakage stopper, so that the watering leakage stopper is corresponding to the first, second, and third inlet holes installed on the cap board of watering control cap for engaging in rotation and linking.
